(19) United States
(12) Patent Application Publication
(10) Pub. No.: US 2015/0302382 A1
(43) Pub. Date: Oct. 22, 2015

(54) SYSTEM FOR MANAGING MULTI-PARTY TRANSACTIONS

(71) Applicant: Klinche, Inc., Alamo, CA (US)

(72) Inventors: Sherratt Reicher, Alamo, CA (US); George Morf, San Anselmo, CA (US)

(73) Assignee: Klinche, Inc., Alamo, CA (US)

(21) Appl. No.: 14/255,153

(22) Filed: Apr. 17, 2014

(51) Int. Cl. G06Q 20/22; G06Q 20/40

(52) U.S. Cl. CPC G06Q 20/227; G06Q 20/405

(57) ABSTRACT

A system and method for processing multiparty transactions, involving multiple payees, are disclosed. A transaction processor receives a first set of order information corresponding to an agreement between a customer and a first payee. The transaction processor further receives a second set of order information corresponding to an agreement between the first payee and a second payee. The transaction processor then receives payment from the customer. A first payout authorization is detected from the customer and the first payee. A second payout authorization is detected from the first payee and the second payee. Upon detecting the first and second payout authorizations, the transaction processor disburses at least a portion of the payment to the first payee and to the second payee based, at least in part, on the first set of order information and the second set of order information, respectively.

### TECHNICAL FIELD

The present embodiments relate generally to multiparty transactions, and specifically to managing and processing multiparty transactions involving multiple payees.

### BACKGROUND OF RELATED ART

Trade credit is an extension of credit, typically from one business to another, for the purchase of goods and services. For example, trade credit may be regarded as a form of short term financing. However, businesses often extend trade credit to customers who are unable to pay in a timely manner. As a result, the short term financing may turn into a long term loan. In a worst case scenario, the trade credit may become non-performing or bad debt.

The construction (and real estate) industry relies heavily on trade credit for the processing of transactions. For example, in a typical construction scenario, a property owner hires a contractor to improve upon his/her property for an agreed amount. The contractor then purchases building materials (e.g., lumber, tiles, paint, etc.) from a supplier on credit (i.e., trade credit), with an agreement allowing the contractor to pay the supplier upon receipt of payment from the property owner. Because the supplier is not in privity of contract (i.e., does not have a contractual relationship) with the property owner, many jurisdictions permit the supplier to attach a lien (e.g., a mechanic's lien) to the property itself. If the supplier is not paid within a reasonable amount of time, it may initiate a foreclosure action against the property to secure payment.

A supplier may be left unpaid for a number of reasons. For example, the contractor may have absconded with the property owner's money without ever completing work on the property. It should be noted, however, that the supplier may have the right to foreclose even if the property owner paid the contractor in full. In such a scenario, the property owner would have to pay the supplier out of pocket and then initiate legal proceedings against the contractor to recover the amount. This problem may be further compounded if the contractor hires one or more sub-contractors to help perform the work, as each sub-contractor may be entitled to its own lien.

Accordingly, a need exists for a system that can manage and process a multiparty transaction in a manner that ensures that each party to the transaction receives its due payment in a timely manner.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A system and method for processing multiparty transactions is disclosed which ensures that multiple payees receive payment for a transaction based on the terms of their agreements with other parties. In accordance with the present embodiments, a transaction processor receives first and second sets of order information along with payment from a customer. The first set of order information corresponds to an agreement between the customer and a first payee. The second set of order information corresponds to an agreement between the first payee and a second payee. The transaction processor then detects a first payout authorization from the first and second payees, and a second payout authorization from the customer and the first payee. Upon detecting the first and second payout authorizations, the transaction processor disburses at least a portion of the payment to the first payee and to the second payee based, at least in part, on the first set of order information and the second set of order information, respectively. In some examples, the first payee may be a contractor and the second payee may be a supplier or a sub-contractor.

The first set of order information may include one or more contractual obligations to be performed by the first payee and an amount to be paid to the first payee upon the completion of such obligations. The second set of order information may include one or more contractual obligations to be performed by the second payee and an amount to be paid to the second payee upon completion of those obligations. For some embodiments, the transaction processor may disburse a portion of the payment to the second payee prior to disbursing a portion of the payment to the first payee.

For some embodiments, the transaction processor may facilitate the transfer of funds between respective bank accounts of the customer, the first payee, and the second payee. For example, the transaction processor may receive authorization information from the customer and request a transfer of the payment, using the authorization information, from a bank account associated with the customer to a processor bank account. The transaction processor may then disburse a first portion of the payment to the first payee by requesting a transfer of the first potion of the payment from the processor bank account to a bank account associated with the first payee. In some embodiments, the first portion of the payment may correspond to the agreed-upon amount to be paid to the first payee (i.e., based on the first set of order information) less a first processing fee. The transaction processor may further disburse a second portion of the payment to the second payee by requesting a transfer of the second portion of the payment from the processor bank account to a bank account associated with the second payee. In some embodiments, the second portion of the payment may correspond to the agreed-upon amount to be paid to the second payee (i.e., based on the second set of order information) less a second processing fee.

Further, for some embodiments, the transaction processor may process lien information, associated with the transaction, on behalf of a lienor and a lienee. For example, the transaction processor may receive a preliminary notice of a lien from the second payee (i.e., the lienee) prior to disbursing respective portions of the payment to the first and second payees. Upon receiving the preliminary notice, the transaction processor may request confirmation of the lien by the customer (i.e., the lienor). The transaction processor may further generate a conditional waiver of the lien, conditioned upon disbursing the portion of the payment to the second payee, and request confirmation of the conditional waiver by the customer. Upon disbursing the portion of the payment to the second payee, the transaction processor may generate an unconditional waiver of the lien and request confirmation of the unconditional waiver by the customer.

Still further, for some embodiments, the transaction processor may retain the first and second sets of order information in a confidential manner. For example, the transaction processor may enable only the customer and/or the first payee to view or modify the first set of order information, while enabling only the first payee and/or the second payee to view or modify the second set of order information. Upon detecting a modification to the first set of order information, the transaction processor may notify at least one of the customer or the first payee (e.g., the party that did not make the modification) of the modification, and clear the first payout authorization. Upon detecting a modification to the second set of order information, the transaction processor may notify at least one of the first payee or the second payee of the modification, and clear the second payout authorization.

For some embodiments, the transaction processor may programmatically file a notice of completion with a recorder's office upon completion of the transaction. For example, the transaction processor may generate a notice of completion subsequent to the disbursement of payment to the first and second payees. Upon receiving confirmation of the notice of completion by each of the first and second payees, the transaction processor may then electronically submit the notice of completion to the recorder's office.

As described in greater detail below, the multiparty transaction processor described herein may ensure that each party to a multiparty transaction receives its due payment in a timely manner. By limiting access to order information to the respective parties to the agreement, the transaction processor may protect the confidentiality of the terms of each agreement. Further, by processing lien information (e.g., preliminary lien notices and/or lien waivers) on behalf of a lienor and a lienee, the transaction processor may ensure that completed transactions are free and clear of any encumbrances relating to the multiparty transaction.

### BRIEF DESCRIPTION OF THE DRAWINGS

The present embodiments are illustrated by way of example and are not intended to be limited by the figures of the accompanying drawings, where:

FIG. 1 shows a transaction processing system in accordance with some embodiments.

FIG. 2 shows a multiparty transaction processor in accordance with some embodiments.

FIG. 3 shows an order processing module in accordance with some embodiments.

FIG. 4 is an illustrative flow chart depicting an exemplary multiparty transaction operation in accordance with some embodiments.

FIGS. 5A-5C are illustrative flow charts depicting a more detailed embodiment of a multiparty transaction operation.

FIG. 6 is an illustrative flow chart depicting an exemplary operation for storing order information in accordance with some embodiments.

FIG. 7 shows a multiparty transaction processor in accordance with other embodiments.

FIG. 8 is a block diagram that illustrates a computer system upon which a transaction processor, in accordance with present embodiments, may be implemented.

FIG. 9 shows an exemplary user interface in which transaction status information is displayed.

Like reference numerals refer to corresponding parts throughout the drawing figures.

### DETAILED DESCRIPTION

The present embodiments are described below in the context of construction contracts for simplicity only. It is to be understood that the present embodiments are equally applicable to multiparty transactions involving any types of goods and/or services. It is also to be understood that the present embodiments are applicable to transactions involving any number of parties (e.g., customers and/or payees). As used herein, the term “customer” may refer to the party providing payment for the entire transaction and/or the recipient or primary beneficiary of goods and/or services. For example, a customer may be the owner of a property that is being renovated or improved upon. Thus, the terms “customer” and “property owner” may be used interchangeably herein. Further, as used herein, the term “payee” may refer to a party which provides goods and/or services to the customer for a fee. For example, a payee may be a contractor or a sub-contractor that improves upon the customer's property, or a supplier that provides raw materials for the improvement. A “user” herein refers to any user of the transaction processing system. For example, a user may be a customer or a payee. Since each user is typically a party to the transaction, the terms “user” and “party” may be used interchangeably herein.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices may be shown in block diagram form to avoid obscuring the present disclosure. The interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

As mentioned above, it would be desirable to automate and/or process multiparty transactions in a manner that ensures that each party to a particular transaction receives its due payment in a timely manner. At least one of the problems associated with conventional multiparty transactions is that payment may be disbursed in a first-in last-out manner. For example, the supplier (e.g., the first party to provide goods/services for a multiparty transaction) would be the last party to receive payment (if at all), since the customer typically deals directly with the contractor (e.g., the last party to provide goods/services for the multiparty transaction) and would rely upon the contractor to then pay the supplier for the building materials. The present embodiments recognize that suppliers and sub-contractors often attach liens to a customer's property, which further complicates matters when a contractor (or sub-contractor) reneges on its obligations to the customer and/or the supplier. Accordingly, the multiparty transaction processing system may disburse payments in a first-in first-out manner to ensure that the customer's property is free and clear of any encumbrances (related to the transaction) upon completion of the transaction. Further, the multiparty transaction processing system disclosed herein may release payment to each payee only when all parties to the multiparty transaction agree to the release.

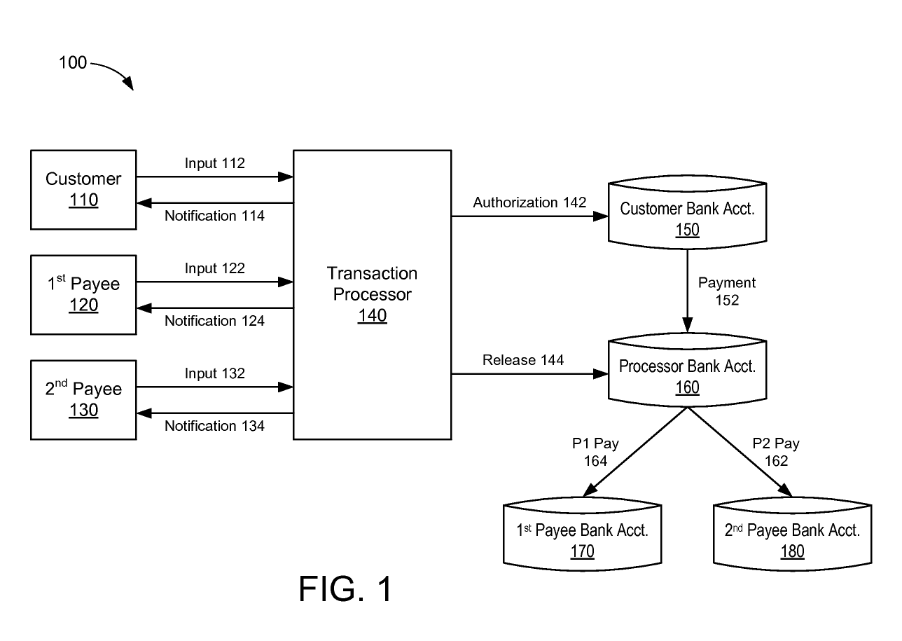

FIG. 1 shows a transaction processing system 100 in accordance with some embodiments. The transaction processing system 100 includes a customer terminal 110, a first payee terminal 120, a second payee terminal 130, and a transaction processor 140. Each of the terminals 110-130 may correspond to a multi-purpose computing device, including mobile computing devices such as computers, smartphones, and/or tablets. The transaction processor 140 may be provided as a network service, such as a cloud-based service, or software deployed in a data center. In some embodiments, the transaction processor 140 is a multiparty transaction processor that manages the collection and distribution of payment among multiple parties and processes information pertaining to a multiparty transaction (e.g., including order and/or lien information). More specifically, the transaction processor 140 may receive inputs (e.g., inputs 112, 122, and 133) from, and provide notifications (e.g., notifications 114, 124, and 134) to, each of the terminals (e.g., terminals 110, 120, and 130, respectively).

A user may access the transaction processor 140 over the Internet, for example, using a web browser. Accordingly, information from the transaction processor 140 may be provided in the form of a web page. To use the transaction processor 140, each party (e.g., customer, first payee, and second payee) may set up an account through a corresponding one of the terminals 110-130. Once the account is set up (e.g., registered), a programmatic token or identifier may be used to associate the user's terminal with the transaction processor 140. Alternatively, a user may “log in” to the transaction processor 140 from any user terminal by specifying account information (e.g., login ID and password) corresponding to the account that user has established with the transaction processor 140. Once all parties (to a particular transaction) have registered with the transaction processor 140, a multiparty transaction may be initiated.

To initiate a multiparty transaction, the customer and/or the first payee may input a first set of order information, corresponding to an agreement between the customer and the first payee, to the transaction processor 140. The first set of order information may include one or more contractual obligations to be performed by the first payee and an amount to be paid to the first payee upon completion of such contractual obligations. For example, where the customer is a property owner and the first payee is a contractor, the first set of order information may correspond to a construction contract for the construction or renovation of a house or building. For some embodiments, the first set of order information may be provided by either the customer or the first payee. For example, the transaction processor 140 may receive the first set of order information as input 112 from the customer terminal 110. The transaction processor 140 may then send a notification 124 to the first payee terminal 120 requesting confirmation of the first set of order information by the first payee. Alternatively, the transaction processor 140 may receive the first set of order information as input 122 from the first payee terminal 120, and send a notification 114 to the customer terminal 110 requesting confirmation by the customer.

After the first set of order information has been recorded, the transaction processor 140 may send a notification 114 to the customer terminal 110 requesting payment for the transaction. The customer may respond to the payment request by providing payment authorization information as input 112 to the transaction processor 140. For some embodiments, the transaction processor 140 may allow the customer to provide payment via direct wire transfer. For example, the payment authorization information may include information identifying a customer bank account 150 (e.g., an account number) as well as the customer's bank (e.g., a routing number). For other embodiments, the transaction processor 140 may allow the customer to provide payment via credit card. For example, the payment authorization information may include credit card information (e.g., card or account number, cardholder's name, expiration date, etc.).

The transaction processor 140 may then use the payment authorization information to acquire funds for the multiparty transaction. For example, the transaction processor 140 may use the authorization information 142 to request a transfer of the payment 152 from the customer bank account 150 to a processor bank account 160. The processor bank account 160 is the bank account associated with the transaction processor 140 and/or a system administrator. For example, the system administrator may be a business, person, or other entity that owns and/or operates the transaction processor 140. It should be noted that the processor bank account 160 is separate from the customer bank account 150 and payee bank accounts 170 and 180, and is not under the control of either the customer or the payees. For some embodiments, the processor bank account 160 may serve as an escrow, wherein the payment 152 is held until all parties agree to its release. This is to ensure that all parties are paid their respective portions of the payment 152 upon completion of the multiparty transaction.

For other embodiments, funds in the processor bank account 160 may be managed by the system administrator. For example, upon completion of the multiparty transaction, each of the payees may be “credited” a respective amount, while the processor bank account 160 retains the payment 152 until a transfer of funds is specifically requested (e.g., as described in greater detail below). Still further, for some embodiments, the transaction processor 140 may use funds from the processor bank account 160 (e.g., including the payment 152) to pay off outstanding debt owed to one or more users of the transaction processing system 100.

Once the multiparty transaction has been created, the first payee (and/or the customer) may add additional parties/payees to the transaction. For example, the first payee may input a second set of order information, corresponding to an agreement between the first payee and a second payee, to the transaction processor 140. The second set of order information may include one or more contractual obligations to be performed by the second payee and an amount to be paid to the second payee upon completion of such contractual obligations. For example, where the first payee is a contractor and the second payee is a supplier, the second set of order information may correspond to a purchase order for a given amount of raw materials and/or goods to be used in the construction or renovation associated with the multiparty transaction. For some embodiments, the second set of order information may be provided by either the first payee or the second payee. For example, the transaction processor 140 may receive the second set of order information as input 122 from the first payee terminal 120. The transaction processor 140 may then send a notification 134 to the second payee terminal 130 requesting confirmation of the second set of order information by the second payee. Alternatively, the transaction processor 140 may receive the second set of order information as input 132 from the second payee terminal 130, and send a notification 124 to the first payee terminal 120 requesting confirmation by the first payee.

A multiparty transaction is typically completed when all payees have fulfilled their contractual duties, and all that is left is for the customer to pay the payees for the goods and/or services they provided. The customer, first payee, and second payee may agree to conclude the transaction by providing a payout authorization (e.g., via respective inputs 112, 122, and 132) to the transaction processor 140. Once the transaction processor 140 determines that a payout has been authorized by all parties, it may then disburse the payment 152 to the first and second payees. For example, the transaction processor 140 may send a release instruction 144 to the processor bank (i.e., the bank associated with the processor bank account 160) requesting a first payout amount (P2 Pay) 162 to be transferred from the processor bank account 160 to a second payee bank account 180, and requesting a second payout amount (P1 Pay) 164 to be transferred from the processor bank account 160 to a first payee bank account 170.

For some embodiments, the transaction processor 140 may retain a portion of the payment 152 (i.e., in the processor bank account 160) as a “processing fee.” The processing fee may be a flat fee (e.g., based on the number of parties involved in the transaction) and/or a percentage of the payment that is to be distributed to each payee. For example, the first payout amount 162 may correspond to the agreed-upon amount to be paid to the second payee (e.g., based on the second set of order information) less a first processing fee (e.g., a percentage of the agreed-upon amount to be paid to the second payee). Similarly, the second payout amount 164 may correspond to the agreed-upon amount to be paid to the first payee (e.g., based on the first set of order information) less a second processing fee (e.g., a percentage of the agreed-upon amount to be paid to the first payee).

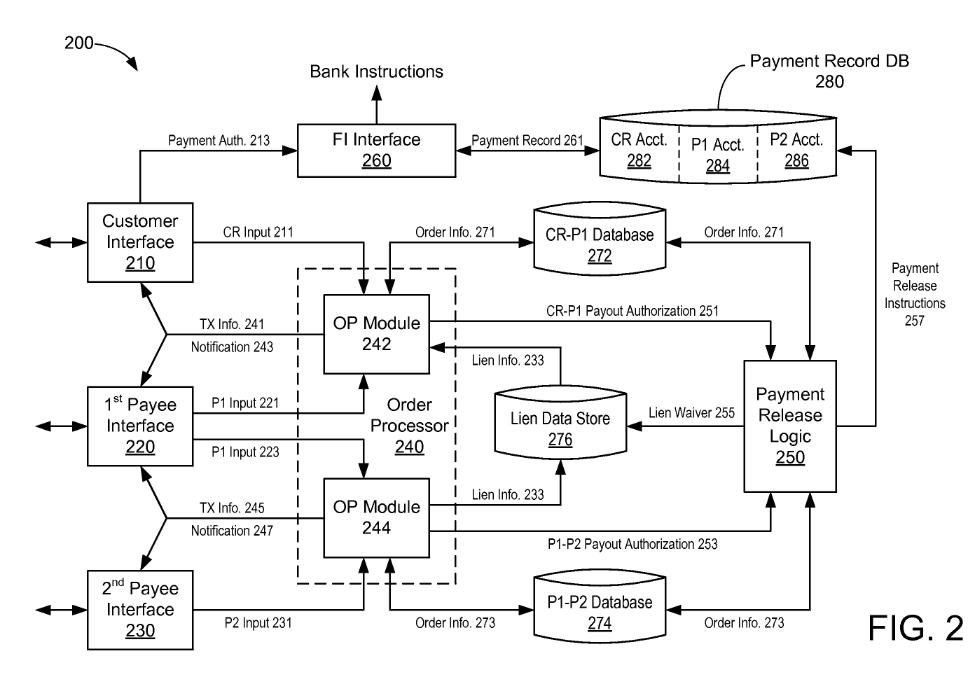

FIG. 2 shows a multiparty transaction processor 200 in accordance with some embodiments. The transaction processor 200 includes a customer interface 210, a first payee interface 220, a second payee interface 230, an order processor 240, payment release logic 250, and a financial institution (FI) interface 260. A user may access or communicate with the transaction processor 200 via one of the user interfaces 210-230, depending on the user's role in a multiparty transaction (e.g., whether the user is a customer, first payee, second payee, etc.). For some embodiments, the user interfaces 210-230 may be provided over the Internet, for example, as a web page. With reference to FIG. 1, the user interfaces 210-230 may be used to communicate with the user terminals 110-130, respectively.

The order processor 240 includes order-processing (OP) modules 242 and 244. The first OP module 242 processes information pertaining to an agreement between the customer and the first payee. For some embodiments, the first OP module 242 may receive user inputs 211 and 221 from the customer interface 210 and the first payee interface 220, respectively. The first set of order information (e.g., specifying the contractual obligations of, and an amount to be paid to, the first payee) may be provided by the customer and/or the first payee as a customer (CR) input 211 and/or a first payee (P1) input 221, respectively. The first set of order information may correspond to a new agreement or a modification of an existing agreement between the customer and the first payee. For example, if the first set of order information is provided by the customer interface 210, the OP module 242 may send a notification 243 to the first payee interface 220 requesting confirmation of the first set of order information. For some embodiments, the OP module 242 may also provide the first set of order information, as transaction (TX) information 241, to the first payee interface 220, for the first payee to review.

The first payee may be allowed to change or modify the first set of order information (e.g., as long as it has not yet been stored or recorded by the OP module 242), prompting the OP module 242 to send a notification 243 to the customer interface 210 requesting confirmation of any changes. For some embodiments, the OP module 242 may also provide the modified order information, as TX information 241, to the customer interface 210, for the customer to review. Once the first set of order information (including any modifications thereto) has been confirmed by the customer and/or the first payee, the OP module 242 may then store the corresponding order information 271 in a first (CR-P1) database 272.

For some embodiments, the parties (e.g., customer and/or first payee) may no longer be allowed to modify the first set of order information 271 once it is stored in the CR-P1 database 272. This may ensure that neither the customer nor the first payee may unilaterally change the terms of their transaction (e.g., contractual obligations, payment amount, bank or payment information, etc.) once those terms have been agreed upon by both parties. For some embodiments, the OP module 242 may identify subsequent attempts to modify the order information 271 already stored in the CR-P1 database 272 as potentially fraudulent activity. For example, the OP module 242 may notify the other party and/or a system administrator of any potentially fraudulent activity. If the changes are approved by the other party and verified by the system administrator (to be non-fraudulent), the OP module 242 may update the order information 271 stored in the CR-P1 database 272 to reflect such changes. For some embodiments, the OP module 242 may allow the other party to terminate the agreement upon detecting such changes to the first set of order information 271. For other embodiments, the OP module 242 may permit certain modifications to be made to the first set of order information 271 even after it is stored in the CR-P1 database 272. For example, changes to “low-risk” information such as customer and/or payee contact information (e.g., phone number, mailing address, etc.) may be permitted by the OP module 242 without raising any red flags.

The second OP module 244 processes information pertaining to an agreement between the first payee and the second payee. For some embodiments, the second OP module 244 may receive user inputs 223 and 231 from the first payee interface 220 and the second payee interface 230, respectively. The second set of order information (e.g., specifying the contractual obligations of, and an amount to be paid to, the second payee) may be provided by the first payee and/or the second payee as P1 input 221 and/or a second payee (P2) input 231, respectively. For some embodiments, the second OP module 244 may ensure that the payment amount specified in the second set of order information does not exceed the total funding for the multiparty transaction (e.g., the payment amount specified in the first set of order information). The second set of order information may correspond to a new agreement or a modification of an existing agreement between the first payee and the second payee. For example, if the second set of order information is provided by the first payee interface 220, the OP module 244 may send a notification 247 to the second payee interface 230 requesting confirmation of the second set of order information. For some embodiments, the OP module 244 may also provide the second set of order information, as TX information 245, to the second payee interface 230, for the second payee to review.

The second payee may be allowed to change or modify the second set of order information (e.g., as long as it has not yet been stored or recorded by the OP module 244), prompting the OP module 244 to send a notification 247 to the first payee interface 220 requesting confirmation of any changes. For some embodiments, the OP module 244 may also provide the modified order information, as TX information 245, to the first payee interface 220, for the first payee to review. Once the second set of order information (including any modifications thereto) has been confirmed by the first payee and/or the second payee, the OP module 244 may then store the corresponding order information 273 in a second (P1-P2) database 274.

For some embodiments, the parties (e.g., first payee and/or second payee) may no longer be allowed to modify the second set of order information 273 once it is stored in the P1-P2 database 274. As described above, this may ensure that neither the first payee nor the second payee may unilaterally change the terms of their transaction once those terms have been agreed upon by both parties. For some embodiments, the OP module 244 may identify subsequent attempts to modify the order information 273 already stored in the P1-P2 database 274 as potentially fraudulent activity. For example, the OP module 244 may notify the other party and/or a system administrator of any potentially fraudulent activity. If the changes are approved by the other party and verified by the system administrator (to be non-fraudulent), the OP module 244 may update the order information 273 stored in the P1-P2 database 274 to reflect such changes. For some embodiments, the OP module 244 may allow the other party to terminate the agreement upon detecting such changes to be made to the second set of order information 273. For other embodiments, the OP module 244 may permit certain low-risk modifications to the second set of order information 273 even after it is stored in the P1-P2 database 274.

It should be noted that the first set of order information 271 may be stored separately from the second set of order information 273. This is to protect the confidentiality of individual agreements between respective parties. For example, the first payee may not want the customer or the second payee to know how much the first payee is profiting from the transaction. Specifically, a contractor would not want a supplier to know the total budget for the transaction, or the property owner to know the total cost of supplies. Thus, for some embodiments, the CR-P1 database 272 may be inaccessible by the OP module 244, whereas the P1-P2 database 274 may be inaccessible by the OP module 242. For example, each of the CR-P1 database 272 and the P1-P2 database 274 may be implemented on an individual memory device.

Alternatively, the CR-P1 database 272 and the P1-P2 database 274 may be implemented as separate partitions of the same memory device.

It should also be noted that, because the first payee is allowed access to (e.g., input, view, and/or modify) the first set of order information 271 and the second set of order information 273, the first payee interface 220 may be configured to interface with both the first OP module 242 and the second OP module 244. More specifically, the first payee interface 220 may filter any inputs pertaining to the first set of order information 271 (i.e., P1 inputs 221) from inputs pertaining to the second set of order information 273 (i.e., P2 inputs 223).

For some embodiments, the second OP module 244 may receive lien information via the second payee interface 230. For example, as described above, the second payee may attach a lien to the customer's property as a form of payment insurance. The requirements for perfecting a lien may vary by jurisdiction. However, in most cases, the lienee (e.g., the second payee) is required to at least give notice to the lienor (e.g., the customer) of the lien. Traditionally, the lienee would send a “preliminary notice” to the lienor by certified mail (i.e., “snail mail”). However, under present embodiments, the second OP module 244 may prompt the second payee (or in some cases, all payees) to input lien information when setting up a multiparty transaction. For example, when entering and/or confirming the second set of order information, via the second payee interface 230, the second payee may be instructed to provide a preliminary notice of a lien (if applicable) or indicate that no liens are attached. The lien information 223 may then be stored in a lien data store 276.

For some embodiments, the first OP module 242 may monitor the lien data store 276 for updates and/or changes to the lien information 233. For example, the OP module 242 may detect when a preliminary notice is first stored in the lien data store 276. The OP module 242 may then send a notification 243 to the customer interface 210 requesting confirmation of the lien. For some embodiments, the OP module 242 may also provide the preliminary notice, as lien information 233, to the customer interface 210, for the customer to review.

Once a total payment amount for the multiparty transaction has been determined (e.g., based on the first set of order information 271), the first OP module 242 may send a notification 243 to the customer interface 210 requesting payment for the transaction. The customer may provide payment authorization information 213, via the customer interface 210, which is then forwarded to the FI interface 260. For example, the payment authorization information 213 may include information identifying a customer bank account 150 (e.g., an account number) and the customer's bank (e.g., a routing number), and/or credit card information (e.g., card or account number, cardholder's name, expiration date, etc.). For some embodiments, the OP module 242 may request additional payment from the customer if subsequent changes are made to the first set of order information 271 (i.e., the customer and the first payee agree to an increased payment amount for the multiparty transaction).

The FI interface 260 may then use the payment authorization information 213 to acquire funds for the multiparty transaction. For example, as described above with reference to FIG. 1, the FI interface 260 may request a transfer of the total payment amount from a customer bank account to a processor bank account. Alternatively, the FI interface 260 may send a payment request to a credit card payment processor, which routes the payment request through the appropriate card network (e.g., Visa, MasterCard, American Express, Discover, etc.) to corresponding a card-issuing bank (e.g., Chase, Citibank, Bank of America, etc.). Assuming the transaction is approved, the card-issuing bank may subsequently transfer the payment amount to the processor bank account.

For some embodiments, the FI interface 260 may store or update a payment record 261 in a payment record database 280 each time it initiates a transfer of funds between bank accounts. More specifically, the payment record database 280 may be sub-divided or partitioned into a customer account 282, a first payee account 284, and a second payee account 286. The customer account 282, first payee account 284, and second payee account 286 store credits for the customer, the first payee, and the second payee, respectively. For example, when the payment amount is deposited in the processor bank account, the FI interface 260 may credit the payment amount to the customer account 282 by storing a corresponding payment record 261 in the payment record database 280.

The customer, first payee, and second payee may agree to conclude the transaction by inputting a payout request to one or more of the OP modules 242 and 244. The OP modules 242 and 244 may then output respective payout authorization signals 251 and 253 to the payment release logic 250. For some embodiments, each OP module 242 and 244 outputs a corresponding payout authorization signal only if a payout request is received from both parties associated with that OP module. For example, the OP module 242 may output or assert the (CR-P1) payout authorization signal 251 only after it receives a payout request via the customer interface 210 and the first payee interface 220. This is to ensure that both parties to a particular contract or agreement are satisfied that the corresponding contractual obligations have been fulfilled and agree to the release of payment. For example, in the construction context, assertion of the CR-P1 payout authorization signal 251 may indicate that the property owner is satisfied with the work completed by the contractor, and the contractor is ready to accept payment for the job performed. Similarly, assertion of the P1-P2 payout authorization signal 253 may indicate that the contractor is satisfied with the materials provided by the supplier, and the supplier is ready to accept payment for the job performed.

For some embodiments, the first OP module 242 may clear (e.g., de-assert or reset) the CR-P1 payout authorization signal 251 if it detects a change or modification to the first set of order information 271 stored in the CR-P1 database 272. The first OP module 242 may further require both the customer and the first payee to resubmit a payout request (e.g., after confirming the changes to the first set of order information 271) in order to assert the CR-P1 payout authorization signal 251 again. Similarly, the second OP module 244 may clear the P1-P2 payout authorization signal 253 if it detects a change or modification to the second set of order information 273 stored in the P1-P2 database 274. The second OP module 244 may further require both the first payee and the second payee to resubmit a payout request (e.g., after confirming the changes to the second set of order information 273) in order to assert the P1-P2 payout authorization signal 253 again.

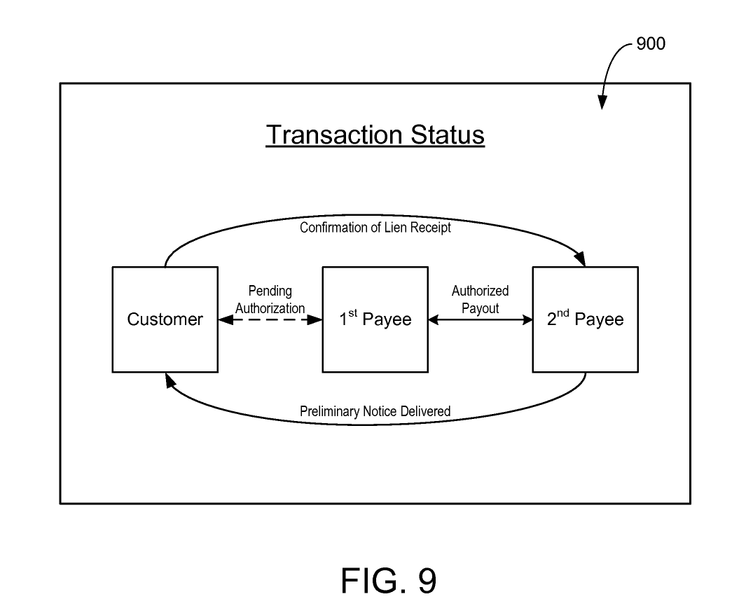

For some embodiments, each party may be allowed to view the overall status of the multiparty transaction at any time. For example, FIG. 9 shows an exemplary user interface 900 in which transaction status information is displayed. The user interface 900 may be provided to the customer, first payee, and second payee, for example, via the customer interface 210, the first payee interface 220, and the second payee interface 230, respectively. For some embodiments, the user interface 900 may indicate which parties have, and which parties have not, authorized the release of payment. In the present example, the user interface 900 shows that the first payee and the second payee have agreed to release payment whereas the customer and the first payee have not. This is often the case when a supplier (e.g., the second payee) has delivered materials to the contractor (e.g. the first payee), but the contractor has not yet completed the work on the customer's property.

For some embodiments, the user interface 900 may also indicate which parties have liens on the customer's property and/or the status of such liens (e.g., preliminary notice delivered/confirmed, conditional waiver delivered/confirmed, unconditional waiver delivered/confirmed). In the present example, the user interface 900 shows that the second payee has delivered a preliminary notice of a lien to the customer and that the second payee has confirmed receipt of the preliminary notice. The user interface 900 may be useful in informing the parties as to the source of any delay in the release of payment and/or completion of the multiparty transaction. The user interface 900 may also be useful in mitigating risk between the parties. For example, if a contract dispute arises between the customer and the first payee, and the first payee reneges on its contractual obligations, the customer may still authorize payment to the second payee to avoid a potential foreclosure action.

For other embodiments, the transaction status information provided to a particular party may include only information directly relevant to that party (such as the status of any direct agreements between that party and another party). For example, transaction status information displayed to the customer may show only the status of the agreement between the customer and the first payee (e.g., indicating that payout authorization is still pending) and/or that a preliminary notice has been received from a second payee. The identity of the second payee may be withheld from the customer along with the status of the agreement between the second payee and the first payee (e.g., indicating that both parties have authorized payout).

Referring again to FIG. 2, payment release logic 250 receives the CR-P1 payout authorization 251 and the P1-P2 payout authorization 253 from the OP modules 242 and 244, respectively, and outputs payment release instructions 257 based on the received signals. For some embodiments, the payment release logic 250 outputs the payment release instructions 257 only if both authorization signals 251 and 253 are asserted (i.e., indicating all parties have agreed to the release). The payment release instructions 257 may indicate an amount to be credited to each of the first payee account 284 and the second payee account 286, and a corresponding amount to be debited from the customer account 282, in the payment record database 280. More specifically, the payment release logic 250 may determine the amount to be credited to each of the first and second payee accounts 284 and 286 based on the first and second sets of order information 271 and 273, respectively. As described above, with reference to FIG. 1, the transaction processor 200 may retain a portion of the total funding for the multiparty transaction as a processing fee (e.g., a flat fee or a percentage). Thus, the amount credited to each of the first and second payee accounts 284 and 286 may be less than the agreed-upon amount specified in the first and second sets of order information 271 and 273, respectively.

It should be noted that the credits stored in the payment record database 280 represent an allocation of funds stored in the processor bank account. For example, an amount credited to the first payee account 284 may correspond to a portion of the funds stored in the processor bank account that are set aside for the first payee. For some embodiments, the credited amount may be transferred to a party's bank account upon request. For example, the actual funds associated with the amount credited to the first payee account 284 may remain in the processor bank account until the first payee requests that they be transferred from the processor bank account to the first payee bank account. For other embodiments, the FI interface 260 may automatically transfer the amount credited to each of the first and second payee accounts 284 and 286 (and/or the customer account 282) from the processor bank account to respective bank accounts associated with the first and second payees upon completion of the multiparty transaction (e.g., as described about with respect to FIG. 1).

For some embodiments, the parties may agree to a partial release of payment (e.g., for partial performance of the contractual obligations specified in the first and second sets of order information 271 and 273). For example, the order information 271 and/or 273 may indicate that payment is to be released in multiple installments, including how much is to be paid out (to each payee) in each installment. Thus, the payment release logic 250 may output payment release instructions 257 for the release of an installment each time both payout authorization signals 251 and 253 are asserted. For some embodiments, the customer alone may authorize the partial release of payment to a lienee (e.g. the second payee), for example, to avoid a lien foreclosure.

For some embodiments, the payment release logic 250 may credit a portion of the payment amount to the second payee account 286 prior to crediting the first payee account 284. As described above, the second payee often fulfills its contractual obligations before the first payee. For example, in the construction context, a supplier must supply the materials before the contractor can complete the work on the customer's property. Thus, it may be desirable to pay out the second payee as soon as it has fulfilled its obligations. This may further ensure that the customer's property is released of any liens (related to the multiparty transaction) prior to completion of the transaction. For example, the order information 271 and/or 273 may indicate that a first installment is to be paid out to the second payee (e.g., upon completion of the second payee's contractual obligations) and a second installment is to be paid out to the first payee (e.g., upon completion of the first payee's contractual obligations or upon conclusion of the multiparty transaction).

In some cases, the first payee may choose to pay the second payee directly (e.g., using funds or credits from the first payee account 284). Thus, for some embodiments, the customer may authorize a reimbursement for expenses incurred by the first payee for the benefit of the multiparty transaction. For example, the first set of order information 271 may indicate that the full payment amount (e.g., for the entire multiparty transaction) is to be paid out to the first payee upon completion of the multiparty transaction (e.g., and conditioned upon the release of any liens by the second payee). Alternatively, and/or in addition, the second set of order information 273 may indicate that the second payee waives its portion of the customer's payment.

Further, for some embodiments, the payment release logic 250 may generate one or more lien waivers on behalf of the second payee. For example, upon detecting that both payout authorization signals 251 and 253 are asserted (and prior to outputting the payment release instructions 257), the payment release logic 250 may generate a “conditional” waiver and release of the lien and store corresponding lien waiver information 255 in the lien data store 276. Specifically, the conditional waiver may indicate that the second payee agrees to release the lien on the customer's property upon receipt of payment. After crediting the second payee account 286, the payment release logic 250 may further generate an “unconditional” waiver and release of the lien, and store corresponding lien waiver information 255 in the lien data store 276. Specifically, the unconditional waiver may indicate that the second payee agrees, unconditionally, to release the lien on the customer's property.

The OP module 242 may detect changes or updates to the lien data store 276 each time new lien waiver information 255 is added. Thus, for some embodiments, the OP module 242 may send a notification 243 to the customer interface 210 requesting confirmation of each (conditional and unconditional) lien waiver. For example, the OP module 242 may provide the lien waiver information 255 to the customer interface 210, for the customer to review and accept.

Still further, for some embodiments, the payment release logic 250 may generate a notice of completion on behalf of the customer. For example, upon outputting payment release instructions 257, the payment release logic 250 may generate a notice of completion to be stored (e.g., as order information 271 and 273) in the databases 272 and 274. Specifically, the notice of completion may mark the conclusion of the multiparty transaction, thereby indicating all contractual obligations have been satisfied. For some embodiments, the payment release logic 250 may (electronically) submit the notice of completion to a county recorder's office (e.g., to update county records).

The OP modules 242 and 244 may detect changes or updates to the databases 272 and 274, respectively, when the notice of completion is stored therein. Thus, for some embodiments, the OP modules 242 and 244 may send respective notifications 243 and 247 (e.g., to the first and second payee interfaces 220 and 230) requesting confirmation of the notice of completion by the respective parties. For example, the OP module 242 may provide the notice of completion to the first payee interface 220, for the first payee to review and accept. Similarly, the OP module 244 may provide the notice of completion to the second payee interface 230, for the second payee to review and accept.

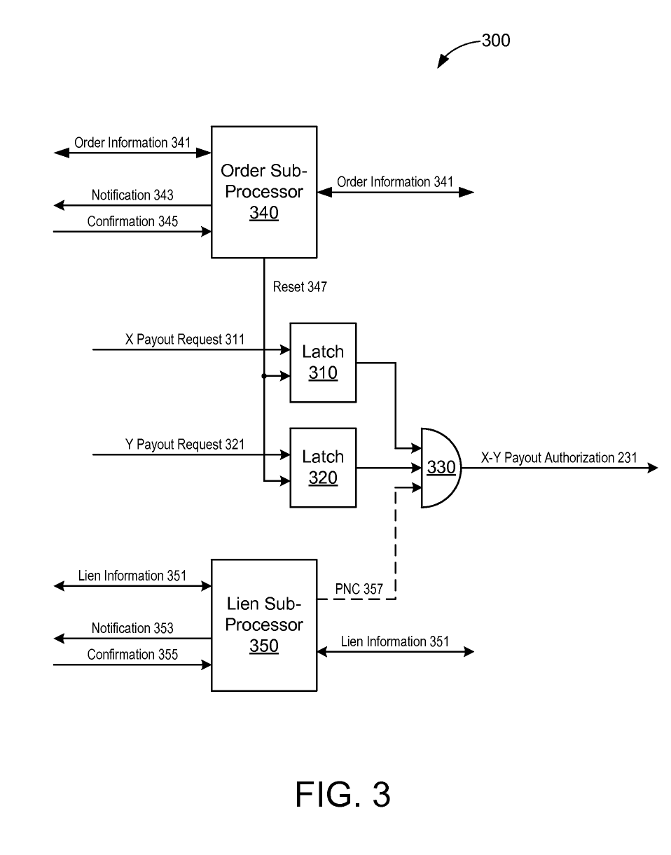

FIG. 3 shows an order processing module 300 in accordance with some embodiments. It should be noted that the order processing module 300 may correspond to any OP module included in the order processor 240, as described above with respect to FIG. 2. Specifically, the order processing module 300 includes a set of latches 310 and 320, an order sub-processor 340, and a lien sub-processor 350. The latches 310 and 320 are coupled to receive payout requests 311 and 321 from a respective pair of user interfaces. For example, assuming the OP module 300 is implemented as OP module 242 of FIG. 2, the first latch 310 may receive the first (X) payout request 311 from the customer interface 210 (e.g., as CR input 211). Accordingly, the second latch 320 may receive the second (Y) payout request 321 from the first payee interface 220 (e.g., as P1 input 221). As used herein, “X” and “Y” denote the two parties to a particular agreement (e.g., CR and P1 or P1 and P2). For some embodiments, the latches 310 and 320 may be implemented as set-reset (SR) latches. Accordingly, the first latch 310 may detect and hold an asserted X payout request signal 311, and the second latch 320 may detect and hold an asserted Y payout request signal 321.

The outputs of the latches 310 and 320 are provided, as inputs, to a logic gate 330. For some embodiments, the logic gate 330 implements AND logic. More specifically, the logic gate 330 may assert a (X-Y) payout authorization signal 231 based on a logical (AND) combination of the outputs of the latches 310 and 320. As a result, the X-Y payout authorization 231 may not be asserted unless both parties X and Y have submitted payout requests (i.e., X payout request 311 and Y payout request 321 have both been asserted).

The order sub-processor 340 processes order information 341 received from a corresponding pair of user interfaces (e.g., customer interface 210 and first payee interface 220) and/or an agreement database (e.g., CR-P1 database 272). For example, the order sub-processor 340 may receive order information 341 from party X and/or from party Y at the start of a multi-party transaction. As described above, the order information 341 may correspond to a brand new agreement or a modification to an existing agreement. Upon receiving the order information 341 from one party (e.g., party X), the sub-processor 340 may then send a notification 343 to the other party (e.g., party Y) requesting confirmation of the order information 341. Upon receiving a confirmation 345, the sub-processor 340 may then store the order information 341 in a corresponding agreement database.

For some embodiments, the order sub-processor 340 may detect changes to a set of order information 341 already stored in an agreement database. Upon detecting such changes, the order sub-processor 340 may output a reset signal 347 to reset the latches 310 and 320, thereby “clearing” the payout requests 311 and 321. Further, for some embodiments, the order sub-processor 340 may detect when a notice of completion has been added to the order information 341 stored in the agreement database. Upon detecting the notice of completion, the order sub-processor 340 may output a notification 343 to the parties X and/or Y requesting confirmation of the notice of completion.

The lien sub-processor 350 processes lien information 351 received from a user interface (e.g., customer interface 210 or second payee interface 230) and/or a lien data store (e.g., lien data store 276). For example, when the OP module 300 is implemented as OP module 244, the lien sub-processor 350 may receive a preliminary notice, as lien information 351, from the second payee interface 230. The lien sub-processor 350 may subsequently store the lien information 351 in the lien data store 276. For some embodiments, the lien sub-processor 350 may parse the lien information 351 from the order information 341. When the OP module 300 is implemented as OP module 242, the lien sub-processor 350 may monitor the lien data store 276 for changes or updates. For example, such changes or updates may include the storing of a preliminary notice, a conditional waiver, and/or an unconditional waiver. Upon detecting new or updated lien information 351, the sub-processor 350 may output a notification 353 to the customer interface 210 requesting confirmation of the lien information 351.

For some embodiments, the lien sub-processor 350 may assert a preliminary notice confirmation (PNC) signal 357 upon receiving a confirmation 355 for a preliminary notice. The PNC signal 357 may be provided as an additional input to a logic gate 330. For example, the PNC signal 357 may be preconfigured to an asserted state, regardless of whether the OP module 300 is implemented as the OP module 242 or the OP module 242. However, upon notifying a customer of a preliminary notice, the corresponding lien sub-processor 350 may de-assert the PNC signal 357 while awaiting confirmation of the preliminary notice. The sub-processor 350 may subsequently reassert the PNC signal 357 after receiving a corresponding confirmation 355. This is to ensure that the customer is on notice of the lien (prior to completing a multi-party transaction) by preventing assertion of the X-Y payout authorization 231 until the customer has confirmed receipt of the preliminary notice.

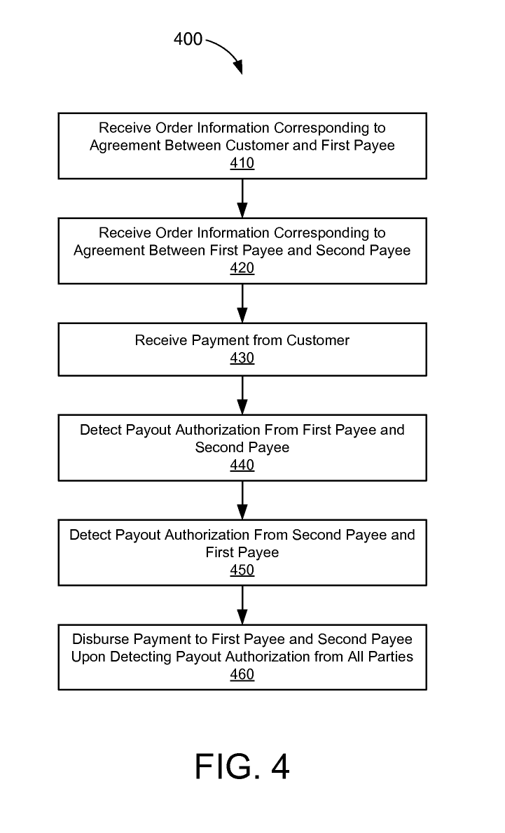

FIG. 4 is an illustrative flow chart depicting an exemplary multiparty transaction operation 400 in accordance with some embodiments. With reference, for example, to FIG. 1, the transaction processor 140 initially receives a first set of order information corresponding to an agreement between a customer and a first payee (410). The first set of order information may include one or more contractual obligations to be performed by the first payee and an amount to be paid to the first payee upon completion of such contractual obligations. For example, the transaction processor 140 may receive the first set of order information as input 112 from the customer terminal 110 and/or as input 122 from the first payee terminal 120.

The transaction processor 140 further receives a second set of order information corresponding to an agreement between the first payee and a second payee (420). The second set of order information may include one or more contractual obligations to be performed by the second payee and an amount to be paid to the second payee upon completion of such contractual obligations. For example, the transaction processor 140 may receive the second set of order information as input 122 from the first payee terminal 120 and/or as input 132 from the second payee terminal 130.

The transaction processor 140 then receives payment for the multiparty transaction from the customer (430). For example, the customer may provide payment authorization information as input 112 to the transaction processor 140. For some embodiments, the payment authorization information may include information identifying a customer bank account (e.g., an account number) and the associated bank (e.g., a routing number). For other embodiments, the payment authorization information may include credit card information (e.g., card or account number, cardholder's name, expiration date, etc.). The transaction processor 140 may then use the payment authorization information to acquire funds for the multiparty transaction. For example, the transaction processor 140 may use the authorization information 142 to request a transfer of the payment amount from the customer bank account 150 (or the card-issuing bank) to the processor bank account 160.

When the second payee has fulfilled its contractual obligations to the satisfaction of the first payee, the transaction processor 140 may detect a first payout authorization from the first payee and the second payee (440). The first payout authorization represents an agreement among the first and second payees to release at least a portion of the payment as specified in the second set of order information. For example, the transaction processor 140 may determine that the first payout has been authorized upon receiving a payout request associated with the second set of order information from each of the first and second payees.

When the first payee has fulfilled its contractual obligations to the satisfaction of the customer, the transaction processor 140 may detect a second payout authorization from the customer and the first payee (450). The second payout authorization represents an agreement among the customer and the first payee to release at least a portion of the payment as specified in the first set of order information. For example, the transaction processor 140 may determine that the second payout has been authorized upon receiving a payout request associated with the first set of order information from each of the customer and the first payee.

Finally, the transaction processor 140 may disburse payment to the first and second payees upon detecting that the payout has been authorized by all parties to the transaction (460). For example, the transaction processor 140 may output release instructions 144 upon detecting both the first payment authorization (with respect to the second set of order information) and the second payment authorization (with respect to the first set of order information). For some embodiments, the release instructions 144 may be provided to the bank associated with the processor bank account 160, requesting a first amount (e.g., the amount specified in the second set of order information less a processing fee) to be transferred to the second payee bank account 180 and a second amount (e.g., the amount specified in the first set of order information less a processing fee) to be transferred to the first payee bank account 170.

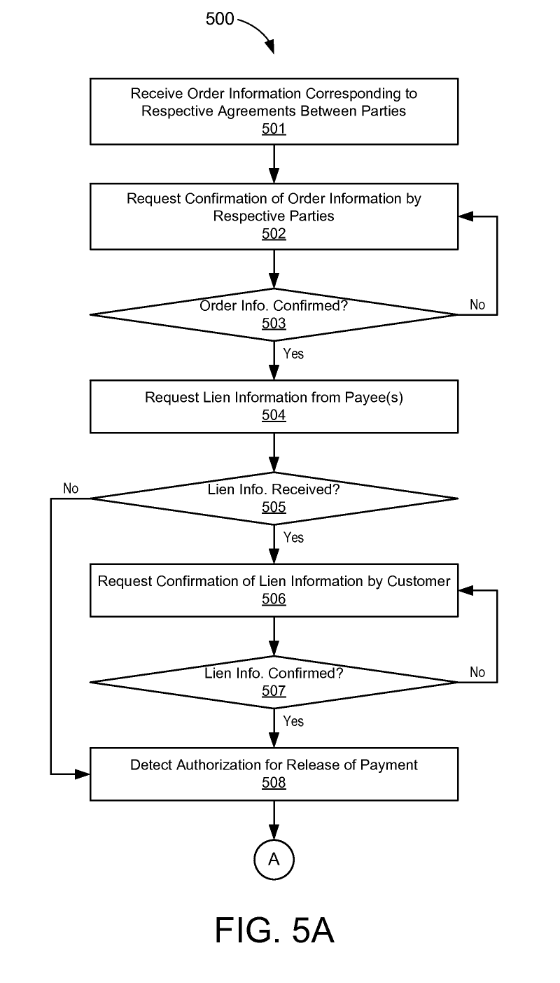

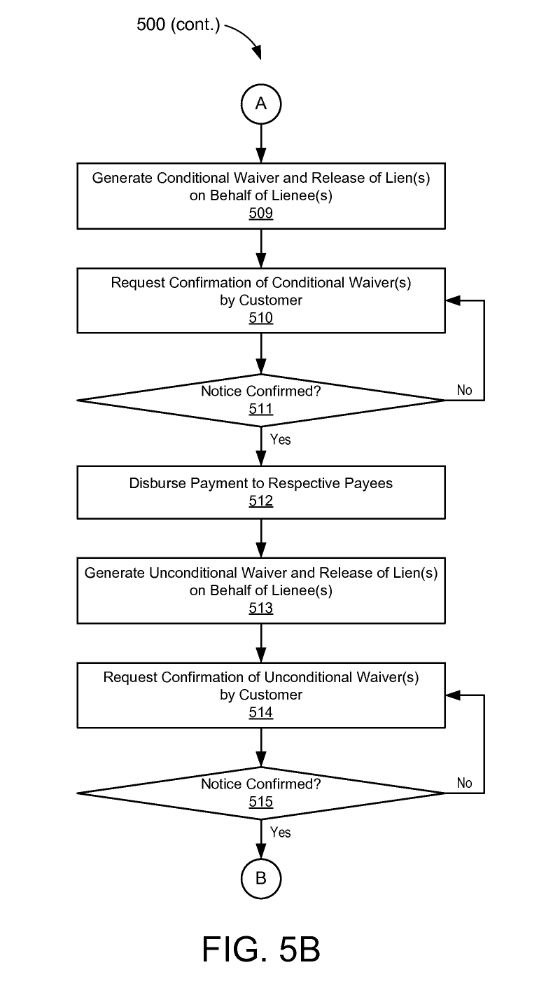

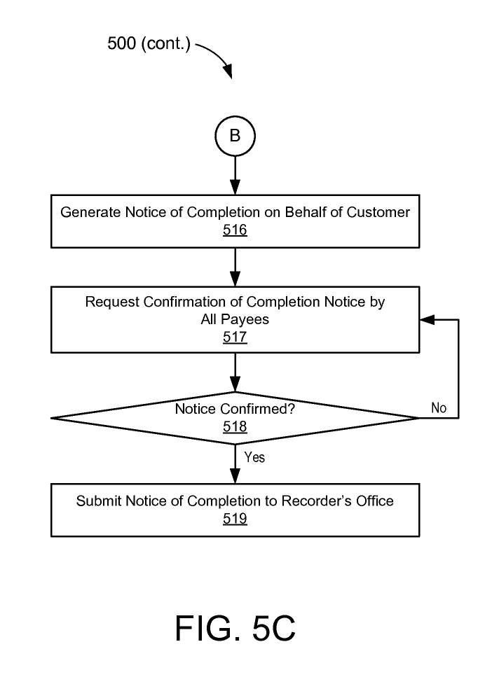

FIGS. 5A-5C are illustrative flow charts depicting a more detailed embodiment of a multiparty transaction operation 500. With reference, for example, to FIG. 4, the transaction processor 200 initially receives order information corresponding to respective agreements between the parties of a multiparty transaction (501). For example, the first OP module 242 may receive a first set of order information (e.g., specifying the contractual obligations of, and a corresponding amount to be paid to, the first payee) from the customer interface 210 and/or the first payee interface 220. Further, the second OP module 244 may receive a second set of order information (e.g., specifying the contractual obligations of, and a corresponding amount to be paid to, the second payee) from the first payee interface 220 and/or the second payee interface 230.

The transaction processor 200 may then request confirmation of the order information by the respective parties (502). For example, the first OP module 242 may send a notification 243 to the customer interface 210 or the first payee interface 220 requesting confirmation of the first set of order information (e.g., depending on whether the customer or the first payee provided the first set of order information). Similarly, the second OP module 244 may send a notification 247 to the first payee interface 220 or the second payee interface 230 requesting confirmation of the second set of order information (e.g., depending on whether the first payee or the second payee provided the second set of order information).

A party may either confirm or modify a corresponding set of order information. For example, the first payee may confirm or modify the first set of order information as provided by the customer, and vice-versa. Similarly, the second payee may confirm or modify the second set of order information as provided by the first payee, and vice-versa. If a party to a particular agreement does not confirm the order information (503), and instead provides changes to the existing order information, the transaction processor 200 may then request confirmation of the changes by the other party to that agreement (502).

Once all order information have been confirmed by all parties to the transaction (503), the transaction processor 200 may then request lien information from one or more of the payees (504). For example, the transaction processor 200 may prompt each payee to either provide information pertaining to a preliminary notice of any lien on the customer's property (if applicable) or indicate that no liens are attached. For some embodiments, each payee may be asked to provide lien information upon inputting and/or confirming the order information (e.g., 501-502). Further, for some embodiments, the transaction processor 200 may retrieve and/or verify lien information by accessing records stored in a title company database.

Upon receiving lien information from one or more payees (505), the transaction processor 200 may proceed by requesting confirmation of the lien information by the customer (506). For example, the first OP module 242 may detect when a preliminary notice is first stored in the lien data store 276. The first OP module 242 may then send a notification 243 to the customer interface 210 requesting confirmation of the lien. To ensure that the customer is aware of any potential liens on its property, the transaction processor 200 may refrain from proceeding any further with the operation 500 until the customer has confirmed receipt of the lien information (506-507).

After the customer has confirmed all lien information (507), or if no lien information was received from the payees (505), the transaction processor 200 may then detect authorization for the release of payment to the payees (508). For example, the customer, first payee, and second payee may agree to complete the multiparty transaction by providing a payout request to one or more of the OP modules 242 and 244. For some embodiments, each OP module 242 and 244 outputs a corresponding payout authorization signal to the payment release logic 250 only if a payout request is received from both parties to a particular agreement. For example, the first OP module 242 may output the CR-P1 payout authorization 251 only after receiving a payout request via each of the customer interface 210 and the first payee interface 220. Similarly, the second OP module 242 may output the P1-P2 payout authorization 253 only after receiving a payout request via each of the first payee interface 220 and the second payee interface 230. For some embodiments, the transaction processor 200 may detect authorization for a partial release of payment (e.g., as described above with respect to FIG. 2).

The transaction processor 200 further generates a conditional waiver and release of lien(s) on behalf of each lienee (509), and requests confirmation of each conditional waiver by the customer (510). The conditional waiver may indicate that a corresponding lienee agrees to release its lien on the customer's property upon receipt of payment. For example, upon detecting that both payout authorization signals 251 and 253 are asserted, the payment release logic 250 may generate one or more conditional waivers (e.g., one for each lien) to be stored in the lien data store 276. The OP module 242 may detect the updated information in the lien data store 276 and send a notification 243 to the customer interface 210 requesting confirmation of each conditional waiver. For some embodiments, the transaction processor 200 may refrain from proceeding any further with the operation 500 until the customer has confirmed receipt of the conditional waiver (510-511).

After the customer has confirmed all conditional waivers (511) the transaction processor 200 may proceed to disburse payment to the respective payees (512). For example, the payment release logic 250 may output payment release instructions 257 indicating a corresponding amount to be credited to each payee account. For some embodiments, the payment release logic 250 may determine the amount to be credited to each payee account based on corresponding order information. For example, the payment release logic 250 may determine the amount to be credited to the first payee account 284 based on the first set of order information 271. Similarly, the payment release logic 250 may determine the amount to be credited to the second payee account 286 based on the second set of order information 273. Further, for some embodiments, the payment release logic 250 may retain a portion of the total funding for the multiparty transaction as a processing fee (e.g., as described above with respect to FIG. 1).

The transaction processor 200 then generates an unconditional waiver and release of lien(s) on behalf of each lienee (513), and requests confirmation of each unconditional waiver by the customer (514). The unconditional waiver may indicate that a corresponding lienee agrees, unconditionally, to release its lien on the customer's property. For example, the payment release logic 250 may generate one or more unconditional waivers (e.g., one for each lien) to be stored in the lien data store 276. The OP module 242 may detect the updated information in the lien data store 276 and send a notification 243 to the customer interface 210 requesting confirmation of each unconditional waiver. For some embodiments, the transaction processor 200 may refrain from proceeding any further with the operation 500 until the customer has confirmed receipt of the unconditional waiver (514-515).

After the customer has confirmed all unconditional waivers (515) the transaction processor 200 may finalize the transaction by generating a notice of completion on behalf of the customer (516), and request confirmation of the notice of completion by all payees (517). The notice of completion may mark the conclusion or termination of the multiparty transaction, thereby indicating that all contractual obligations have been satisfied. For some embodiments, the payment release logic 250 may generate the notice of completion, to be stored with the order information. Once all parties have confirmed receipt of the notice of completion (518), the transaction processor 200 may submit the notice of completion to a county recorder's office.

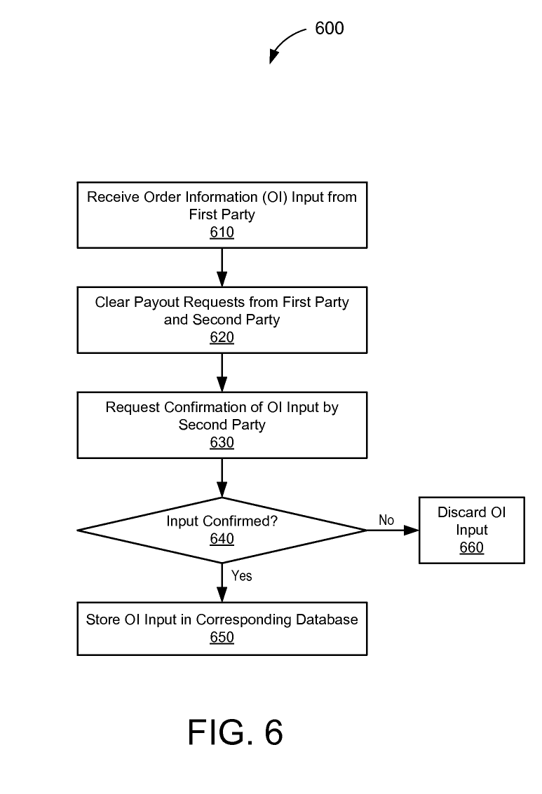

FIG. 6 is an illustrative flow chart depicting an exemplary operation 600 for storing order information in accordance with some embodiments. With reference, for example, to FIG. 3, the OP module 300 receives an order information (01) input from a first party to a particular agreement (610). The order information input may correspond to a new set of order information or changes to an existing set of order information. As described above, the set of order information may correspond to an agreement between two parties of a multiparty transaction. For example, the order sub-processor 340 may receive the order information input (e.g., as order information 341) from the first party to the agreement (e.g., party X or party Y).

The OP module 300 then clears the payout requests from the first party and the second party (620). For example, the order sub-processor 340 may clear the payout requests 311 and 321 by outputting a reset signal 347 to reset the latches 310 and 320, respectively. This is to ensure that a multiparty transaction does not proceed to completion (i.e., to prevent the X-Y payout authorization signal 231 from being asserted) without express agreement by both parties as to the terms of the transaction.

The OP module 300 may further request confirmation of the OI input by the second party to the agreement (630). For example, the order sub-processor 340 may send a notification 343, to a user interface associated with the second party, requesting confirmation of the OI input. For some embodiments, the order sub-processor 340 may further notify the second party as to whether the OI input represents a new agreement between the respective parties (i.e., party X and party Y), or whether the OI input represents a change or modification to an existing agreement between the parties.

The second party may either confirm or reject the OI input provided by the first party. For example, the second party may confirm the OI input by providing a confirmation input 345 in response to the notification 343. Alternatively, the second party may reject the OI input provided by the first party by entering a new OI input (e.g., as order information 341) in response to the notification 343. If no confirmation is received (640), the OP module 300 may discard the OI input provided by the first party (660). For some embodiments, the order sub-processor 340 may subsequently output a notification 343, to a user terminal associated with the first party, requesting confirmation of the new OI input (i.e., as provided by the second party).

If the second party confirms the OI input (640), the OP module 300 proceeds to store the OI input in a corresponding agreement database (650). For example, the order sub-processor 340 may forward the OI input (e.g., as order information 341) to a particular agreement database associated with the OP module 300. As described above, the agreement database may correspond to a memory device specifically allocated for storing order information between the first party and the second party (e.g., party X and party Y). Alternatively, the agreement database may correspond to a memory partition specifically assigned to store order information between the first party and the second party.

It should be noted that the embodiments described herein are not limited to multiparty transactions involving three parties. Rather, once a multiparty transaction is created (e.g., between a customer and a first payee), any number of additional payees may be subsequently added to the transaction. For example, a multiparty transaction based on a construction contract (i.e., between a property owner and a general contractor) may involve any number of sub-contractors and/or suppliers.

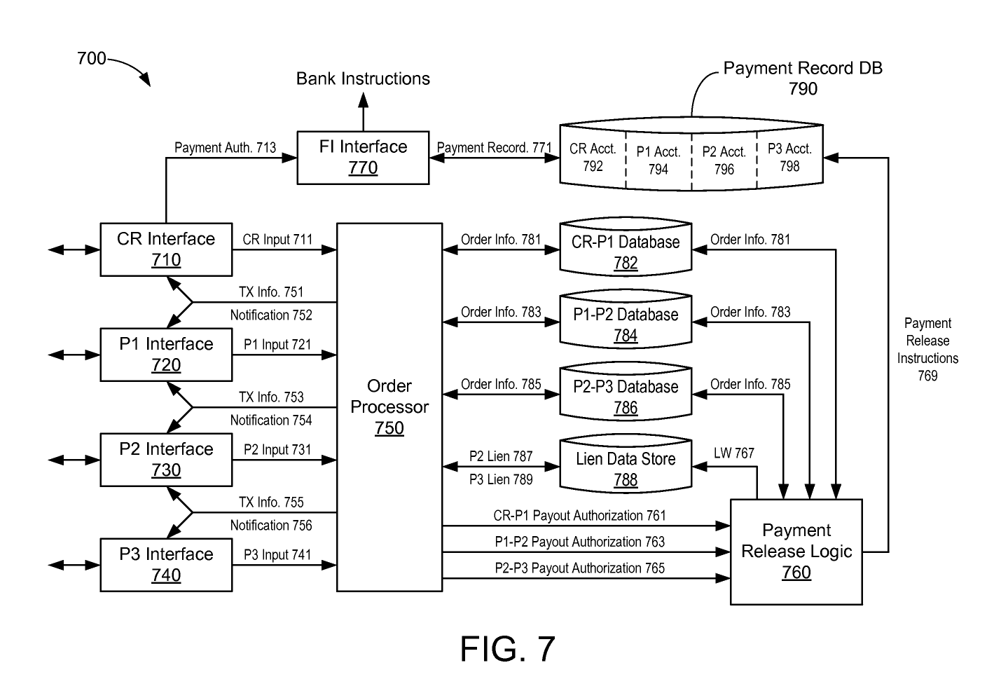

FIG. 7 shows a multiparty transaction processor 700 in accordance with other embodiments. The transaction processor 700 includes a customer interface 710, a first payee interface 720, a second payee interface 730, a third payee interface 740, an order processor 750, payment release logic 760, and an FI interface 260. The transaction processor 700 may perform substantially the same function as transaction processor 200, described above with respect to FIG. 2. However, whereas the transaction processor 200 included two payee interfaces (220 and 230), transaction processor 700 includes three payee interfaces 720-740. For example, a property owner, a general contractor, a sub-contractor, and a supplier may carry out a multiparty transaction using the customer interface 710, the first payee interface 720, the second payee interface 730, and the third payee interface 740, respectively. As described above, the user interfaces 710-740 may be provided over the internet, for example, as a web page.

The FI interface 770 processes payment transfer requests between financial institutions (e.g., banks). For example, the FI interface 770 may receive payment authorization information 713 via the customer interface 710, and use the authorization information 713 to retrieve payment/funding for a corresponding multiparty transaction. As described above, the payment authorization information may include the customer's bank information (e.g., an account number and routing number) and/or credit card information (e.g., car or account number, cardholder's name, expiration date, etc.). For some embodiments, the FI interface 770 may store or update a payment record 771 in a payment record database 790 each time it initiates a transfer of funds between bank accounts. For example, the payment record database 790 may be sub-divided or partitioned into a customer account 792, a first payee account 794, a second payee account 796, and a third payee account 798.

The order processor 750 processes inputs 711, 721, 731, and 741 from respective user interfaces 710-740. Although not shown for simplicity, the order processor 750 may include a number of OP modules (e.g., as described above with respect to FIGS. 2 and 3) to process information pertaining to agreements between respective pairs of users (e.g., CR-P1, P1-P2, and P2-P3). For example, the order processor 750 may receive a first set of order information via the customer interface 710 and/or the first payee interface 720, and provide transaction information 751 and notifications 752 to the pair of interfaces 710 and 720. The order processor 750 may further receive a second set of order information via the first payee interface 720 and/or the second payee interface 730, and provide transaction information 753 and notifications 754 to the pair of interfaces 720 and 730. Still further, the order processor 750 may receive a third set of order information via the second payee interface 730 and/or the third payee interface 740, and provide transaction information 755 and notifications 756 to the pair of interfaces 730 and 740. As described above, the first, second, and third sets of order information may specify the contractual obligations of, and an amount to be paid to, the first, second, and third payees, respectively.

For some embodiments, the order processor 750 may ensure that the payment amount specified in the second set of order information does not exceed a payment amount allocated for the first payee (e.g., as specified in the first set of order information). Further, the order processor 750 may ensure that the payment amount specified in the third set of order information does not exceed a payment amount allocated for the second payee (e.g., as specified in the second set of order information).

The order processor 750 stores order information 781, 783, and 785 (that is approved by both parties) in agreement databases 782, 784, and 786, respectively. For some embodiments, each set of order information 781, 783, and 785 may be stored in a separate memory device or a separate partition of the same memory device (e.g., to protect the confidentiality of individual agreements between respective parties). For example, information stored in the CR-P1 database 782 may be accessible to only the customer interface 710 and the first payee interface 720; information stored in the P1-P2 database 784 may be accessible to only the first payee interface 720 and the second payee interface 730; and information stored in the P2-P3 database 786 may be accessible to only the second payee interface 730 and the third payee interface 740.

For some embodiments, the order processor 750 may receive lien information via the second payee interface 730 and/or the third payee interface 740. For example, in the construction scenario, both the sub-contractor (e.g., the second payee) and the supplier (e.g., the third payee) may be entitled to a lien on the customer's property, since neither party is in direct contract with the customer. Thus, the order processor 750 may prompt the second and third payees to input lien information when setting up a multiparty transaction. Lien information 787, received via the second payee interface 730, may be stored alongside lien information 789, received via the third payee interface 740, in the lien data store 788. The order processor 750 may further send a notification 752 to the customer interface 710 requesting confirmation of each lien stored in the lien data store 788.

The order processor 750 may further output payout authorization signals 761-765 upon receiving payout requests from respective user interface-pairs (e.g., CR-P1, P1-P2, and P2-P3). For example, the order processor 750 may assert the CR-P1 payout authorization 761 upon receiving a corresponding payout request from each of the customer interface 710 and the first payee interface 720 (i.e., with respect to the first set of order information 781). The order processor 750 may further assert the P1-P2 payout authorization 763 upon receiving a corresponding payout request from each of the first and second payee interfaces 720 and 730 (i.e., with respect to the second set of order information 783). Still further, the order processor 750 may assert the P2-P3 payout authorization 765 upon receiving a corresponding payout request from each of the second and third payee interfaces 730 and 740 (i.e., with respect to the third set of order information 785). For some embodiments, the order processor 750 may clear one or more of the payout authorization signals 761-765 if it detects a change or modification to a corresponding set of information 781, 783, and/or 785.

The payment release logic 760 receives the payout authorization signals 761-765 and outputs payment release instructions 769 based on the received signals. For some embodiments, the payment release logic 760 may output the payment release instructions 769 only if all of the authorization signals 761-765 are asserted. The payment release instructions 769 may indicate an amount to be credited to each of the payee accounts 794-798, and debited from the customer account 792, based on the stored order information 781, 783, and 785. For some embodiments, the payment release logic 760 may withhold a processing fee from the amount credited to each payee account 794-798. Further, for some embodiments, the payment release logic 760 may credit the payee accounts 794-798 in installments. For example, the payment release logic 760 may output payment release instructions 769 for the release of an installment each time all payout authorization signals 761-765 are asserted.

For some embodiments, the payment release logic 760 may credit the payee accounts 794-798 in a first-in first-out manner. For example, the payment release logic 760 may credit a portion of the payment amount to the third payee account 798 prior to crediting the first or second payee accounts 794 and 796. The payment release logic 760 may then credit a portion of the payment amount to the second payee account 796 prior to crediting the first payee account 794. As described above, with respect to FIG. 2, this is to ensure that the payees are paid in the order that work (i.e., delivery of goods and/or services) is completed. This may also ensure that the customer's property is released of any liens (related to the multiparty transaction) prior to completion of the transaction.

Further, for some embodiments, the payment release logic 760 may generate one or more lien waivers on behalf of each lienee (e.g., the second and/or third payee). For example, upon detecting that the payout authorization signals 761-765 are asserted (and prior to outputting the payment release instructions 769), the payment release logic 760 may generate a conditional waiver on behalf of each of the second and third payees, and store corresponding lien waiver information 767 in the lien data store 768. After crediting the third payee account 798, the payment release logic 760 may generate an unconditional waiver on behalf of the third payee, and store corresponding lien waiver information 767 in the lien data store 768. Then, after crediting the second payee account 796, the payment release logic 760 may generate an unconditional waiver on behalf of the second payee, and store corresponding lien waiver information 767 in the lien data store 768. For some embodiments, the order processor 750 may further provide the lien waiver information 767, stored in the lien data store 768, to the customer interface 710, for the customer to review and accept.

Still further, for some embodiments, the order processor 750 may generate a notice of completion on behalf of the customer. For example, upon outputting payment release instruction 769, the payment release logic 760 may generate a notice of completion to be stored in the agreement databases 782-786. The order processor 750 may then provide the notice of completion to each of the payee interfaces 720-740, for each payee to review and accept. Once all payees have accepted the notice of completion, the transaction processor 700 may then submit the notice of completion to a county recorder's office, thereby concluding and terminating the multiparty transaction.

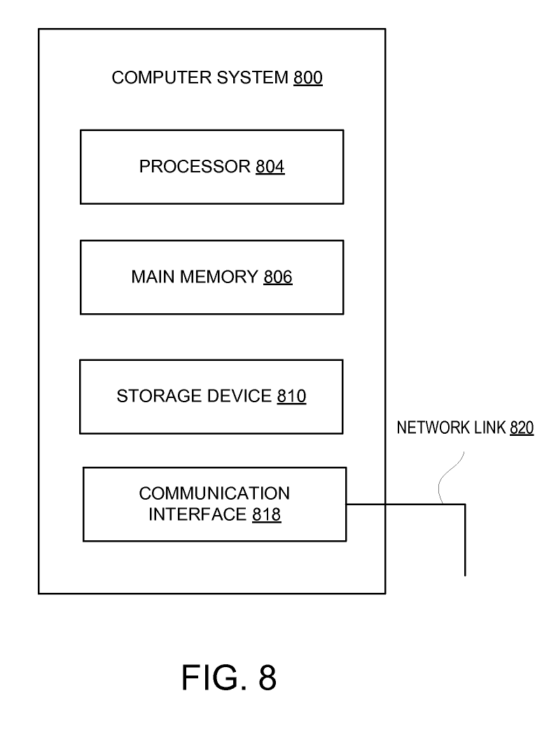

FIG. 8 is a block diagram that illustrates a computer system upon which embodiments described herein may be implemented. For example, in the context of FIGS. 2 and 3, the multiparty transaction processors 200 and 300 may be implemented using one or more servers such as described by FIG. 8.

In an embodiment, computer system 800 includes processor 804, memory 806 (including non-transitory memory), storage device 810, and communication interface 818. Computer system 800 includes at least one processor 804 for processing information. Computer system 800 also includes the main memory 806, such as a random access memory (RAM) or other dynamic storage device, for storing information and instructions to be executed by processor 804. Main memory 806 also may be used for storing temporary variables or other intermediate information during execution of instructions to be executed by processor 804. Computer system 800 may also include a read only memory (ROM) or other static storage device for storing static information and instructions for processor 804. The storage device 810, such as a magnetic disk or optical disk, is provided for storing information and instructions. The communication interface 818 may enable the computer system 800 to communicate with one or more networks through use of the network link 820 (wireless or wired line). The communication interface 818 may communicate with one or more users (i.e., parties to a particular multiparty transaction) using, for example, the Internet.

Embodiments described herein are related to the use of computer system 800 for implementing the techniques described herein. According to one embodiment, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement embodiments described herein. Thus, embodiments described are not limited to any specific combination of hardware circuitry and software.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for conducting a multiparty transaction, the method being implemented by one or more processors and comprising:
receiving a first set of order information corresponding to an agreement between a customer and a first payee; and
receiving a second set of order information corresponding to an agreement between the first payee and a second payee;
receiving payment from the customer;
detecting a first payout authorization from the first payee and the second payee;
detecting a second payout authorization from the customer and the first payee; and
upon detecting the first and second payout authorizations, disbursing at least a portion of the payment to the first payee and to the second payee based, at least in part, on the first set of order information and the second set of order information, respectively.

2. The method of claim 1, wherein the first set of order information includes:
one or more contractual obligations to be performed by the first payee; and
a first amount to be paid to the first payee upon completion of the one or more contractual obligations by the first payee.

3. The method of claim 2, wherein the second set of order information includes:
one or more contractual obligations to be performed by the second payee; and
a second amount to be paid to the second payee upon completion of the one or more contractual obligations by the second payee.

4. The method of claim 1, wherein the first payee is a contractor and wherein the second payee is a supplier or a sub-contractor.

5. The method of claim 1, wherein a first portion of the payment is disbursed to the first payee prior to disbursing a second portion of the payment to the second payee comprises.

6. The method of claim 1, wherein receiving payment from the customer comprises:
receiving authorization information from the customer; and
requesting a transfer of the payment, using the authorization information, from a bank account associated with the customer to a processor bank account.

7. The method of claim 6, wherein the processor bank account is independent of the first payee, the second payee, and the customer.

8. The method of claim 3, wherein disbursing the at least portion of the payment comprises:
requesting a transfer of a first portion of the payment, based on the first set of order information, from a processor bank account to a bank account associated with the first payee; and
requesting a transfer of a second portion of the payment, based on the second set of order information, from the processor bank account to a bank account associated with the second payee.

9. The method of claim 7, wherein the first portion corresponds to the first amount less a first processing fee, and wherein the second portion corresponds to the second amount less a second processing fee.

10. The method of claim 1, further comprising, prior to the disbursing:
receiving a preliminary notice of a lien from the second payee; and
requesting confirmation of the lien by the customer.

11. The method of claim 10, further comprising:
generating a conditional waiver of the lien, wherein the conditional waiver indicates that the second payee agrees to release the lien upon receiving payment; and
requesting a confirmation of the conditional waiver by the customer.

12. The method of claim 11, further comprising:
generating an unconditional waiver of the lien subsequent to disbursing the at least portion of the payment to the second payee, wherein the unconditional waiver indicates that the second payee agrees, unconditionally, to release the lien;
requesting a confirmation of the unconditional waiver by the customer.

13. The method of claim 1, further comprising:
enabling only the customer or the first payee to view or modify the first set of order information.

14. The method of claim 13, further comprising:
detecting a modification to the first set of order information; and
notifying at least one of the customer or the first payee of the modification to the first set of order information.

15. The method of claim 14, further comprising:
clearing the first payout authorization upon detecting the modification to the first set of order information.

16. The method of claim 1, further comprising:
enabling only the first payee or the second payee to view or modify the second set of order information.

17. The method of claim 16, further comprising:
detecting a modification to the second set of order information; and
notifying at least one of the first payee or the second payee of the modification to the second set of order information.

18. The method of claim 17, further comprising:
clearing the second payout authorization upon detecting the modification to the first set of order information.

19. The method of claim 1, further comprising:
generating a notice of completion based, at least in part, on the disbursement of payment; and
requesting confirmation of the notice of completion by each of the first payee and the second payee.

20. A multiparty transaction processing system, comprising:
a memory to store:
a first set of order information corresponding to an agreement between a customer and a first payee; and
a second set of order information corresponding to an agreement between the first payee and a second payee.
one or more processors to:
receive payment from the customer;
detect a first payout authorization from the first payee and the second payee;
detect a second payout authorization from the customer and the first payee; and
upon detecting the first and second payout authorizations, disburse at least a portion of the payment to the first payee and to the second payee based, at least in part, on the first set of order information and the second set of order information, respectively.

21. A computer-readable storage medium containing program instructions that, when executed by a processor provided within a communications device, causes the device to:
receive a first set of order information corresponding to an agreement between a customer and a first payee; and
receive a second set of order information corresponding to an agreement between the first payee and a second payee;
receive payment from the customer;
detect a first payout authorization from the first payee and the second payee;
detect a second payout authorization from the customer and the first payee; and
upon detecting the first and second payout authorizations, disburse at least a portion of the payment to the first payee and the second payee based, at least in part, on the first set of order information and to the second set of order information, respectively.
